(19) United States
(12) Patent Application Publication
(10) Pub. No.: US 2010/0091308 A1
(43) Pub. Date: Apr. 15, 2010

(54) Image Processing Apparatus and Recording Medium

(75) Inventor: Satoru ONO, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/559,301

(22) Filed: Sep. 14, 2009

(30) Foreign Application Priority Data
Oct. 9, 2008 (JP) 2008-262722

(51) Int. Cl. H04N 1/60

(52) U.S. Cl. 358/1.9; 358/519

(57) ABSTRACT

An image processing apparatus for performing a color converting process in which image data of an original document is converted into image data expressed in a color space corresponding to a coloring material used in an output apparatus, the image processing apparatus includes: a conversion information generating unit which generates data for the color converting process when the color converting process is performed, the data corresponding to one or more images included in the image data of the original document; and a color converting unit which performs the color converting process using the data for the generated color converting process, the data corresponding to the image data of each image. The data for the color converting process includes information which is used to convert the image data of the image before conversion such that the image data is expressed in one color of the coloring material.

### BACKGROUND

1. Technical Field

The present invention relates to an image processing apparatus and the like which perform a color conversion process on an image, and more particularly, to an image processing apparatus and the like which can perform a proper color conversion process according to the content of an image.

2. Related Art

A copying apparatus reads images on an original document and performs processes of for reproducing the image on another print material. In general, the following data conversion process is carried out in the processes. First, a process is carried out in which image data of the original document, which is obtained by a scanner and expressed in a color expression format (for example, the RGB format) of the scanner, is converted into an expression representing an absolute colorific value such as a Lab format. Thereafter, a process is carried out in which the converted data is converted into the color expression format (for example, the CMYK format) of a recording agent (coloring material) which is used in the printer as an output apparatus. Finally, the copying apparatus prints the image according to the resulting data. Then, in each of the two operations of the color conversion, a conversion table (for example, a lookup table (LUT)), which reflects the apparatus characteristics depending on the apparatus, is used to realize an accurate color reproduction.

In JP-A-10-200769, a color conversion apparatus for printing colors is described which enables a user to reproduce a favorite color. There is disclosed a technique in which a color tone is shifted such that contamination of ink for printing is decreased to an acceptable deviation range in connection with colors visible to humans, which is a range in which the contamination is noticeable when mixing the inks for printing.

However, in the known apparatus described above, there may some errors when the color conversion is performed, and moreover it is likely that the color conversion characteristics will change due to the aging degradation in the apparatus. Therefore, there is some danger that the color on the original document will be deviated when it is printed. As a result, another color is output to be mixed with the portion expressed in the primary color (a recording agent of one color) on the original document, so that the color of the portion is muddied and the visual quality is damaged. In addition, since the sheet status (the status of textiles) can differ from place to place even though it is the same color, when the original document is read by a scanner, variation can occur in reading the original document; for example, the original document may be read as a different color. In addition, because of the errors in reading the original document, the image to be originally expressed in the primary color may be mixed with another color.

In addition, in JP-A-10-200769, there is disclosed a technique in which the color tone is shifted such that the contamination is decreased in order to solve the problem. However, in the known apparatus which take into account such a technique, the conversion table, which includes the operation of shifting the color, is prepared in advance, and the conversion table is set for use for the processing of the target images.

However, even though images have the same color, there may a case where the images are reproduced in the primary color or a case where the images are not reproduced in the primary color according to the images. In addition, when the same conversion table is uniformly used, it is impossible to always obtain high image quality. For example, it may be that the color of flesh in the image is reproduced as the primary color of yellow. In addition, when the color is not shifted completely, another color may be mixed with the image to be reproduced in the primary color because of the reason described above.

### SUMMARY

An advantage of some aspects of the invention is to provide an image processing apparatus and the like which perform a color conversion process on an image, and more particularly, to an image processing apparatus and the like which can perform a proper color conversion process according to the content of an image.

According to an aspect of the invention, an image processing apparatus performs a color converting process in which image data of an original document obtained by a reading apparatus is converted into image data expressed in a color space corresponding to a coloring material used in an output apparatus. The image processing apparatus includes: a conversion information generating unit which generates data for the color converting process when the color converting process is performed, and the data corresponds to each image included in the image data of the original document; and a color converting unit which performs the color converting process using the data for the generated color converting process, and the data corresponds to the image data of each image.

In the image processing apparatus, it is preferable that the data for the color converting process includes information which is used to convert the image data such that the image data is expressed in one color of the coloring material used in the output apparatus after conversion in a case where the colorific value of the image data before conversion is positioned in a predetermined region in a predetermined color space.

In the image processing apparatus, it is preferable that the predetermined region is determined on the basis of a range including an edge portion in the image and a portion, which has a color approximating to the color of the edge portion, in the vicinity of the edge portion, and on the basis of a primary color region in the predetermined color space.

In the image processing apparatus, it is preferable that the data for the color converting process is generated for each object included in the image data of the original document.

In the image processing apparatus, it is preferable that the data for the color converting process is generated on the basis of the kind of the object.

According to another aspect of the invention, an image processing apparatus performs a color converting process in which image data of an original document obtained by a reading apparatus is converted into image data expressed in a color space corresponding to a coloring material used in an output apparatus. The image processing apparatus is switched to perform the color converting process such that pixels having the same colorific value of the image data are expressed in one color of the coloring material used in the output apparatus, or expressed in plural colors of the coloring material used in the output apparatus according to the image of the image data which is an object of the color converting process.

According to still another aspect of the invention, an image processing program causes an image processing apparatus to perform a color converting process in which image data of an original document obtained by a reading apparatus is converted into image data expressed in a color space corresponding to a coloring material used in an output apparatus. The program causes the image processing apparatus to perform: a conversion information generating step for generating data for the color converting process when the color converting process is performed, the data corresponding to each image included in the image data of the original document; and a color converting step for performing the color converting process using the data for the generated color converting process corresponding to the image data of each image.

Other objects and characteristics of the invention will be apparent from embodiments of the invention to be described below.

### BRIEF DESCRIPTION OF THE DRAWINGS

The invention will be described with reference to the accompanying drawings, wherein like numbers reference like elements.

FIG. 1 is a view schematically illustrating a configuration of a copying apparatus provided with an image processing apparatus according to an embodiment of the invention.

FIG. 2 is a view illustrating an example of a chart 2.

FIG. 3 is a view illustrating a quasi-Pure region.

FIG. 4 is a flowchart illustrating an example of a procedure at the time of performing a copying process.

FIG. 5 is a flowchart illustrating an example of a procedure for generating an individual LUT.

FIG. 6A is a view illustrating an FG region and a BG region.

FIG. 6B is a view illustrating an FG region and a BG region.

FIG. 7A is a view illustrating a Pure region, a Non-Pure region, and an individual LUT.

FIG. 7B is a view illustrating a Pure region, a Non-Pure region, and an individual LUT.

### DESCRIPTION OF EXEMPLARY EMBODIMENTS

In the following, an embodiment of the invention will be described with reference to the accompanying drawings. However, the technical scope of the invention is not limited to such an embodiment. Further, in the description, the same or similar components will be designated by the same reference numerals in the drawings.

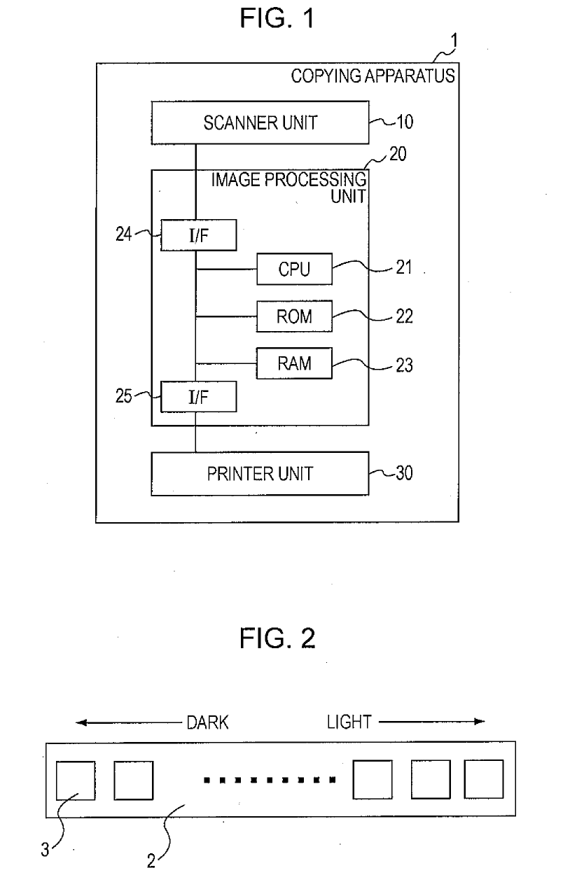

FIG. 1 is a view schematically illustrating a configuration of a copying apparatus provided with an image processing apparatus according to an embodiment of the invention. An image processing unit 20 shown in FIG. 1 is the image processing apparatus applying the invention, and performs a process of converting the image data of an original document, which is obtained by a scanner unit 10, into data for a printer unit 30. When performing the process, the image processing unit 20 dynamically generates a color conversion table for each processing target image on the basis of each color conversion table (a lookup table (LUT)) which is prepared in advance and of an region (hereinafter, called as a quasi-Pure region) in a color space in which a color to be output as a primary color is already included. Then, the color converting process is performed by using the generated table, and proper primary coloring is realized according to the content of the target image, so that it is possible to output a high quality image.

A copying apparatus 1 according to the embodiment of the invention shown in FIG. 1 includes the scanner unit 10 which serves as a reading apparatus for reading the original document, the image processing unit 20 which serves as the image processing apparatus described above, and the printer unit 30 which serves as an output apparatus.

The scanner unit 10 is provided with a mechanism unit which reads an image on the original document and a control unit which controls the mechanism unit and generates the image data of the read image, neither of which are illustrated in the drawing. The image data generated by the control unit is data which includes the density gradation values of the respective RGB colors (red, green, and blue) of each pixel constituting the image, and the data is transmitted to the image processing unit 20 as scanner input data.

Next, as described above, the image processing unit 20 serves to convert the scanner input data obtained from the scanner unit 10 into printer output data for the printer unit 30. As shown in FIG. 1, the image processing unit 20 is provided with a CPU 21, a ROM 22, a RAM 23, an I/F 24, and an I/F 25. The I/Fs 24 and 25 serve as interfaces with the scanner unit 10 and the printer unit 30, respectively.

The CPU 21 performs a process of converting the data, and more particularly, converts the scanner input data expressed in the RGB colors into data of the colorific values (Lab color system), and thereafter converts the data of the colorific value into data of CMYK (cyan, magenta, yellow, and black) colors which are the recording agents used in the printer unit 30. The image processing unit 20 is characterized in the color converting process. As described above, the image processing unit 20 is particularly characterized in that the color conversion table is dynamically generated, which will be described in detail later. Further, the processes carried out by the CPU 21 are performed according to various kinds of programs stored in the ROM 22.

In the ROM 22 contains, in advance, data to be used in the color converting process other than the programs described above. For example, the color conversion table (pre-stage LUT) used for conversion from the RGB expression into the Lab expression, the color conversion table (normal LUT) used for conversion from the Lab expression to the CMYK expression, the color conversion table (Pure LUT), in which the data representing the quasi-Pure region described above and the primary coloring by the quasi-Pure region are taken into account, used for conversion from the Lab expression into the CMYK expression, and the like are contained in the ROM 22.

The pre-stage LUT is used to convert the scanner input data expressed in the RGB colors into the data of the Lab color system. The pre-stage LUT contains the Lab values of the colorific values corresponding to each grid point (a coordinate value of the RGB) in the RGB three-dimensional space. The table is created such that the color on the original document is obtained as the accurate colorific value (Lab value) according to the device characteristics of the scanner unit 10 in the copying apparatus 1.

A normal LUT is used to convert the image data obtained as the Lab value into the printer output data in the CMYK expression. The normal LUT contains the CMYK values corresponding to each grid point (Lab value) in the Lab three-dimensional space. The table is created such that each color tone itself expressed by the Lab value is accurately output according to the device characteristics of the printer unit 30 in the copying apparatus 1. Further, in the normal LUT, a shift of a color tone is not carried out in order to output the primary color in the original document, which may be obtained as a different colorific value during scanning, as the primary color. In other words, the normal LUT is an LUT in which the primary coloring based on the quasi-Pure region described above is not taken into account.

As described above, the quasi-Pure region is a region in the color space (the Lab space) in which the color to be output as the primary color is already included, and in which data defining the region can be obtained. In addition, the Pure LUT is an LUT in which the primary coloring based on the quasi-Pure region is taken into account in the normal LUT. The data representing the quasi-Pure region, the content of the Pure LUT, and a generation method will be described later.

Next, the RAM 23 serves as a storage unit which temporarily stores the scanner input data input from the scanner unit 10, the data generated in the color converting process described above, the printer output data obtained after the correcting process, and the like.

Next, the printer unit 30 serves to perform printing on a printing medium on the basis of the printer output data, which is output from the image processing unit 20, obtained after the correcting process. The printer unit 30 is provided with a control unit and a mechanical unit, neither of which is illustrated in FIG. 1. The control unit receives the printer output data, instructing the mechanism unit to perform the printing according to the data, and controlling the operations of the respective portions of the mechanism unit. In addition, the mechanism unit is provided with a photosensitive body, a charging unit, an exposure unit, a developing unit, a transfer unit, and the like, and performs a printing process on the printing medium such as paper on the basis of the printer output data. By the printing of the printer unit 30, the image on the original document read by the scanner unit 10 is copied.

As described above, the copying apparatus 1 having a configuration such as the one described above is characterized in the color converting process carried out by the image processing unit 20. First, the quasi-Pure region and the Pure LUT will be described in detail.

The following operations are carried out on the copying apparatus 1 before use (before shipping) so as to prepare the data representing the quasi-Pure region and the Pure LUT, both of which are registered in the ROM 22.

First, the scanner unit 10 scans a chart 2 for a predetermined primary color (for example, yellow or black), on which plural patches 3 are printed using the primary colors different in density (gradation). That is, the scanner unit 10 reads plural patch images. Then, the plural charts 2 are prepared for each printing condition such as the kinds of the medium (the paper) or the printing method, and the scanner unit 10 scans the plural charts 2. For example, the chart for printing on recycled paper, the chart for the same conditions as general printing material, and the like are scanned.

FIG. 2 is a view illustrating an example of the chart 2 described above. On the chart 2 shown in FIG. 2, the plural patches 3 are printed using the same primary color but different from each other in density. For example, the density is divided into several tens of stages from the lightest color to the darkest color, and the patches 3 having the density corresponding to each stage are printed. In this way, the plural charts 2 are prepared as described above.

After scanning, a colorimetric result of each patch 3 in every chart 2 is generated as RGB data by the scanner unit 10. At this time, the RGB data on every pixel in each patch 3 is obtained according to the resolution of the scanner unit 10. Thereafter, the RGB data is converted into the Lab data by the pre-stage LUT described above. Then, an average of the Lab values of each pixel in the patch is calculated for every patch 3. The calculated average value is set as the representative Lab value of the patch 3.

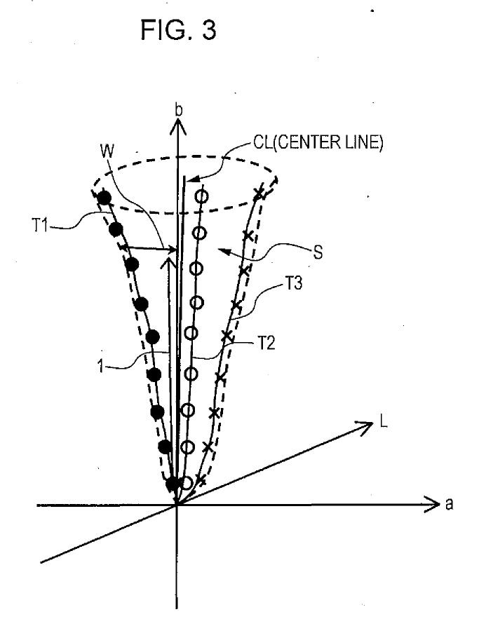

Thereafter, the representative Lab value of each patch 3 in every chart 2 is plotted in the Lab three-dimensional color space. FIG. 3 is a view illustrating the three-dimensional color space as an example. In FIG. 3, the Lab three-dimensional color space is shown, in which points marked with black circles, white circles, and the symbol “x” are the plotted points of the representative Lab values described above. In this example, the scanning is performed on three kinds of the charts 2, and the plotted points marked with the same symbol represent the patches 3 on the same chart 2. In addition, T1, T2, and T3 shown in FIG. 3 represent approximated curves of the respective charts 2 based on the plotted points of the representative Lab values, respectively.

Next, a center line CL of the quasi-Pure region S to be set and the gradation value of the primary color corresponding to each point on the center line are determined from the plotted points of the representative Lab values in every chart 2. As an example of the determination scheme, the points of the coordinates are obtained by averaging the coordinates of the plotted points of the representative Lab values with respect to the same density patches 3 on the plural charts 2 (three charts 2 in the example shown in FIG. 3), and then the obtained points are sequentially plotted. The center line CL is obtained by taking an approximated curve passing through the plotted points. Then, the gradation value corresponding to the density of the associating patch 3 is assigned to each plotted point on the center line CL. That is, the gradation value is assigned for each patch 3 in which the plotted point is obtained by averaging. The example shown in FIG. 3 is a case where the primary color is yellow. In general, since the yellow of the primary color exists on a position substantially overlapped with the b axis in the Lab space, the obtained center line CL becomes a line approximating to the b axis.

Thereafter, a radius W is determined from each plotted point on the obtained center line CL. The radius W is a radius on a plane perpendicular to the center line CL which passes the plotted point. The radius W is determined such that intersection points between the approximated curves T1, T2, and T3 described above and the plane are included in a circle of the radius W around the plotted point. The quasi-Pure region S is a region which is surrounded by aligning the circles each having the radius W from each plotted point on the center line CL along the center line CL. In the example shown in FIG. 3, the conical region marked with the dotted line represents the quasi-Pure region S. The quasi-Pure region S is a region in which the representative Lab values of each chart 2 described above are substantially included.

The quasi-Pure region S as determined above is expressed by the data representing the obtained center line CL, the data representing each plotted point on the center line CL, the radius W from each plotted point, and the density gradation value in each plotted point, and these data are stored in the ROM 22 as the data representing the quasi-Pure region S.

Further, the above-mentioned quasi-Pure region S and the generation method are merely an example. Any kind of original document can be employed with another region and another generation method as long as the region in the Lab space substantially includes the color to be output as the primary color. For example, in the example described above, the quasi-Pure region S may be determined such that the region does not include substantially the representative Lab values of each chart 2 but substantially includes the Lab values of each pixel in each patch 3 before obtaining the representative Lab values by averaging. In this case, the quasi-Pure region S is defined as an increased region.

In addition, the quasi-Pure region S may be determined to be a cylindrical region with a predetermined width (radius) around a standard line as a center axis in the Lab space in which the primary color (for example, a yellow) is positioned upon outputting.

Next, the Pure LUT is generated by correcting the normal LUT described above. First, it is checked whether or not each grid point (Lab value), which is assigned with the CMYK value in the above-mentioned normal LUT, in the Lab space is positioned in the defined quasi-Pure region S. In the check, the length of the vertical line from the position of the target grid point to the center line CL of the quasi-Pure region S described above is compared with the width W from the point on the center line CL obtained by lowering the vertical line along the center line CL. When the length of the vertical line is shorter than the width W, it is determined that the position of the grid point is in the quasi-Pure region S.

In addition, when it is determined that the position of the grid point is in the quasi-Pure region S, the position of the grid point is moved to the position of the point on the center line CL which is positioned at the end of the vertical line. Then, the gradation values of the CMYK colors in the normal LUT associated with the grid point are changed into the gradation values of the primary color assigned to the point on the moved center line CL. When the primary color corresponds to K, the gradation values of the CMYK of (10, 0, 5, 98) are changed into the gradation values of (0, 0, 0, 100), for example.

That is, when the color of each grid point is positioned in the quasi-Pure region S, the LUT is corrected such that the color is expressed only by the primary color upon outputting. Further, when the width W and the gradation values are not assigned to the point on the center line CL before lowering the vertical line, the width W and the gradation values are calculated by interpolating the points which are positioned at the front and rear positions and assigned with these values.

The Pure LUT generated as described above is stored in the ROM 22.

Further, the quasi-Pure region S is defined for each color necessary to be the primary coloring, for example, the yellow and the black. The correction of the normal LUT described above is performed on the entire quasi-Pure region S to generate the Pure LUT.

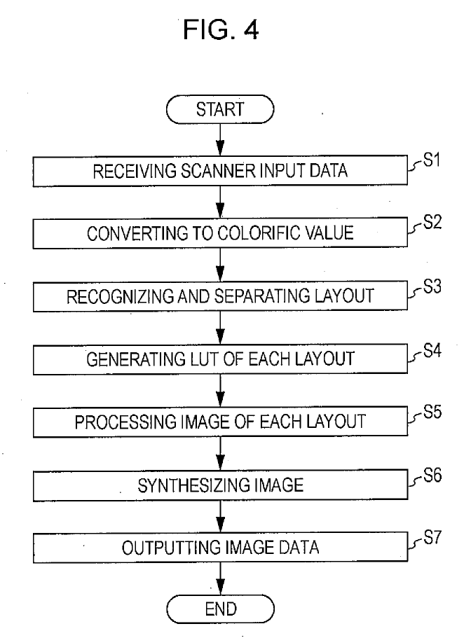

Next, the process content at the time of performing the copying process which is performed in the image processing unit 20 of the copying apparatus 1 will be described now. FIG. 4 is a flowchart illustrating an example of a procedure at the time of performing the copying process.

First, the image data (the scanner input data) of the original document is input from the scanner unit 10 (step S1). Next, as described above, since the input data is in a form where each pixel has the gradation values of the RGB colors, the color expression in the RGB colors is converted into the expression in the colorific values (Lab) (step S2). In this conversion process, the pre-stage LUT described above is used. As the result of the conversion process, the image data comes to be a form in which each pixel has each Lab value.

Thereafter, the image processing unit 20 separates the processing target image (data) into layouts (step S3). Here, the layout is a unit of the image process including the color converting process which is performed by the image processing unit 20. The LUT for the color conversion, which is described later, is generated for each layout. In addition, the layout may be configured to include one layout of the entire processing target image (the entire original document). However, in this case, it is assumed that each object included in the image is configured to be one layout. In general, as the kinds of the object constituting the image, there are a photograph (image), a graphic, a text (characters), and the like. Here, each of these objects is assumed to be each layout.

The layout separation is carried out such that the objects are recognized in the processing target image and the image data is separated from each recognized object. As for the recognition of the object carried out by a known scheme, a scheme for determining the object by the amount of the edge portion by extracting the edge portion of the image, a scheme using Fourier conversion, and a scheme for determining the object on the basis of the histogram shape of the pixel value, and the like may be employed.

Next, the LUT (the individual LUT) for the color conversion is generated regarding each separated layout (step S4). The generation process is performed on the entire separated layouts described above. That is, the individual LUT is dynamically generated regarding each layout (each portion of the processing target image) at a point of time when the copying is processed. The individual LUT is a color conversion table which is used to convert the color from the Lab expression to the CMYK expression, which is obtained by correcting the content of the Pure LUT described above to make it suitable for the image of the layout. Specifically, the colorific value to be shifted to the primary color based on the quasi-Pure region S is sorted out when it is needed in the image of the layout.

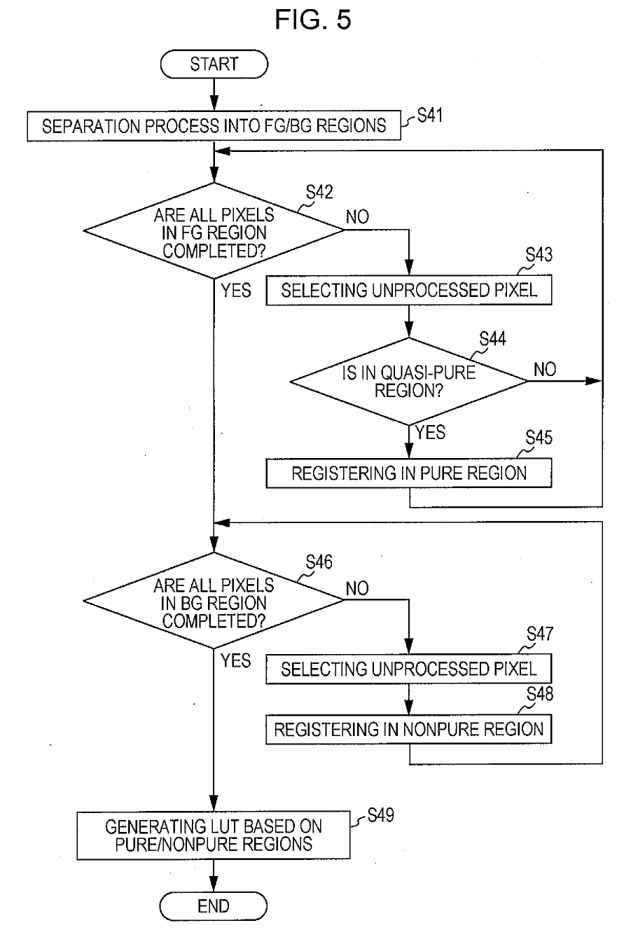

FIG. 5 is a flowchart illustrating an example of a procedure for generating an individual LUT. In the following, the generation of the content of each individual LUT will be described with reference to FIG. 5.

First, the image of the target layout is separated into the foreground region (FG region) and the background region (BG region) (step S41). Here, the FG region is an edge portion and a vicinity thereof in the image and corresponds to a portion of the color approximating to that of the edge portion. In addition, the BG region corresponds to a portion other than the FG region. Therefore, a text or a graphic in which there is no change in color is separated into the FG region.

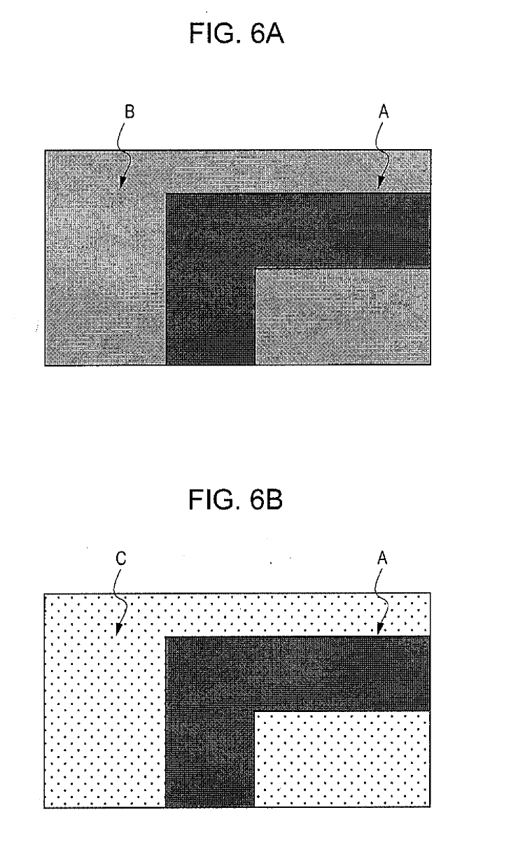

Specifically, the edge portion is extracted from the change of the pixel value in the layout, and the pixel values which are continuous are determined from the extracted edge portion. Then, the portion which ranges from the edge portion to a largely changed pixel is determined as the FG region. FIGS. 6A and 6B are views illustrating the FG region and the BG region. An example shown in FIG. 6A shows an image in which a region (the portion marked with “A” shown in the drawing) exists where the background has a constant color different from the background (the portion marked with “B” shown in the drawing) having a constant color. In addition, the color of the background B is a color (for example, a blue) which need not be the primary color upon outputting. The region marked with “A” is assumed as the color (for example, a gray) to be the primary color upon outputting. In this case, the background B and the region A are separated into the FG region on the basis of the definition of the FG region described above.

On the other hand, the background of an example shown in FIG. 6B is different from the case shown in FIG. 6A. In this case, the background C is irregular in color. For example, the image is a photograph. In this case, the region A is separated into the FG region, and the background C is classified into the BG region.

In this way, when the FG region is extracted and the FG region and the BG region are separated from each other, it is first determined for all the pixels in the FG region whether or not the colorific values (Lab values) of each pixel are positioned in the quasi-Pure region described above in the Lab space (steps S42 to S44). In this determination, the data, which is registered in the ROM 22, representing the quasi-Pure region is used. The specific determination method is equal to the determination of whether or not the position of the grid point is positioned in the quasi-Pure region S when the above-mentioned Pure LUT is generated.

Then, when it is determined that the position of the grid point is positioned in the quasi-Pure region (Yes in step S44), the pixel is registered to the Pure region (step S45). Here, the Pure region is a region in the Lab space in which the colorific value to be output as the primary color is positioned when the image of the layout is output. As to the pixel registered to the Pure region, the colorific value (Lab value) of the pixel is stored as the Pure region.

On the other hand, when it is determined that the position of the grid point is not in the quasi-Pure region (No in step 544), the registration is not carried out.

Next, a process of registering all the pixels in the BG region to the Non-Pure region is performed on each pixel (steps S46 to S48). Here, the Non-Pure region is a region in the Lab space in which the colorific value not to be output as the primary color is positioned when the image of the layout is output. As to the pixel registered to the Non-Pure region, the colorific value (Lab value) of the pixel is stored as the Non-Pure region.

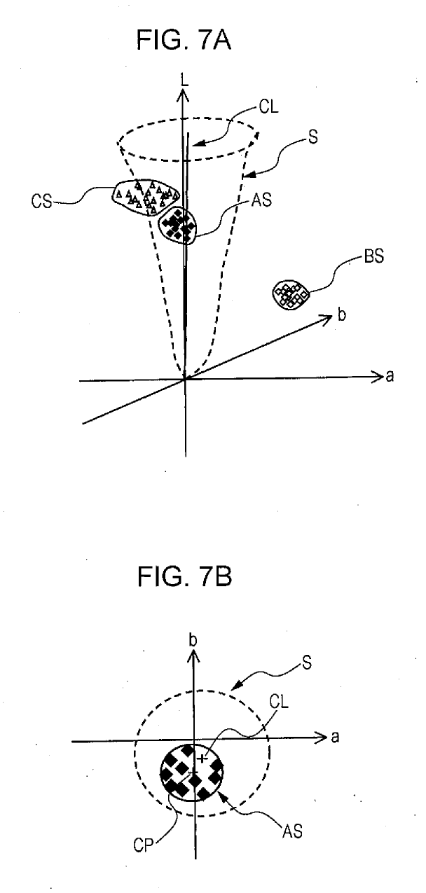

FIGS. 7A and 7B are views illustrating the Pure region, the Non-Pure region, and the individual LUT. FIG. 7A is a view illustrating the quasi-Pure region S (the region marked with a dotted line in the drawing) in which the primary color is black as an example. In the drawing, the regions marked with AS, BS, and CS represent the regions in which the calorific values of each image of the region A, the background B, and the background C which are separated into the FG region and the BG region in the images shown in FIGS. 6A and 6B.

The region A is classified into the FG region as described above and the entire region is registered to the Pure region by the processes (S42 to 545) performed on the FG region. Therefore, the corresponding region AS exists in the quasi-Pure region S. Similarly, the background B is classified into the FG region, but the entire region is positioned outside of the quasi-Pure region S and thus not registered to the Pure region by the processes (S42 to S45) performed on the FG region. Therefore, the corresponding region BS is not overlapped with the quasi-Pure region S. In addition, the background C is classified into the BG region as described above and the entire region is registered to the Non-Pure region by the processes (S46 to S48) performed on the BG region. In this example, the corresponding region CS is partially overlapped with the quasi-Pure region S as shown in FIG. 7A.

Next, when the registration of the Pure region and the Non-Pure region is completed, the individual LUT is generated regarding the layout using the Pure region and the Non-Pure region (step S49).

In this process, the individual LUT is generated such that the pixel having the Lab value registered to the Pure region is output in the primary color, and the pixel having the Lab value registered in the Non-Pure region is not output in the primary color.

Specifically, as an example of such a method, the individual LUT is generated such that the grid points included in the Pure region (for example, AS shown in FIGS. 7A and 7B) among the grid points in the Lab space associated with the CMYK values in the normal LUT stored in the ROM 22 described above are associated with the CMYK values which are associated with the generated Pure LUT stored in the ROM 22. Therefore, in the generated individual LUT, the color values before and after the conversion are associated with each other, so that when being converted into the CMYK value, the Lab value in the Pure region is shifted so as to be one color (for example, the color of K) in the CMYK colors, and the Lab value outside the Pure region is not shifted similarly to the conversion in the normal LUT.

In addition, as another method, the individual LUT may be generated such that the grid points included in the Non-Pure region (for example, CS shown in FIG. 7A) among the grid points in the Lab space associated with the CMYK values in the Pure LUT stored in the ROM 22 described above are associated with the associated CMYK values in the generated normal LUT stored in the ROM 22. In this case, in the generated individual LUT, the color values before and after the conversion are associated with each other, so that when being converted into the CMYK value, the Lab value in the Non-Pure region is not shifted so as not to be one color (for example, the color of K) in the CMYK colors, or the Lab value in the quasi-Pure region other than the Non-Pure region is shifted so as to be one color in the CMYK colors.

Specifically, in the generation of the individual LUT, the grid points of the normal LUT or the Pure LUT are determined, which most approximate to the colorific values (Lab values) registered to the Pure region or the Non-Pure region, and the grid points can be set as the grid points included in the Pure region or the Non-Pure region.

In addition, as another method, it may be performed such that, similar to the case of the quasi-Pure region S described above, the center line is determined from each colorific value registered to the Pure region or the Non-Pure region, the Pure region or the Non-Pure region is defined on the center line and in the circle range around each position on the center line, and the grid points are determined similarly to the case of the generation of the Pure LUT.

Further, the Pure region and the Non-Pure region may be overlapped with each other in some cases. However, even when the individual LUT is generated by any one of methods described above, whether or not there is an overlapped portion is checked, and if so, the overlapped portion is removed by setting the portion to any one of the regions according to a predetermined rule, and then the individual LUT is generated. For example, when the layout is an object of a text or a graphic, the overlapped portion is set to the Pure region. When the layout is an object of a photograph, the overlapped portion is set to the Non-Pure region. As a result, the image of the text or the graphic to be reproduced in the primary color upon output is implemented to be the primary color without fail. On the other hand, it is possible to prevent a color of the photograph, which is not to be the primary color upon output, from being the primary color.

In the example shown in FIGS. 7A and 7B, the individual LUT is generated such that the region AS becomes the Pure region and the colorific values of the grid points in the region are represented by the color of K. On the other hand, the individual LUT is generated such that the region CS becomes the Non-Pure region and the colorific values of the grid points in the region are not represented by the color of K. Further, FIG. 7B is a view illustrating the quasi-Pure region taken on a plane perpendicular to the L axis at the position of the region AS, and, referring to the drawing, it can be seen that the Pure region AS is included in the quasi-Pure region S. Further, the symbol CL in the drawing indicates the position of the center line of the quasi-Pure region S, and the symbol CP indicates the position of the center line of the region AS.

In this way, the individual LUT is generated. In the FG region described above, that is, the portion with a high possibility of being text or a graphic, the LUT is generated such that the color included in the quasi-Pure region, that is, the color to be originally expressed as the primary color, is output by the primary color. Since the LUT is generated such that the BG region described above, that is, the portion, in which the image has a high possibility of being a photograph or the like, is not output by the primary color, it is possible to generate the proper LUT according to the image content of the layout.

Next, returning to FIG. 4, the image process is performed on each layout by the generated individual LUT described above (step S5). Specifically, the individual LUT is generated for the image data of each layout by the processes described above. Since each image data is in the form of the Lab expression as described above, the image data of each layout is converted into the data in the form of the CMYK by the corresponding individual LUT. Thereafter, according to the kind of the object of each layout, the image process is completed by properly implementing the processes to improve the image quality such as moiré removal and edge emphasis.

Thereafter, the image data of each layout after the image process is synthesized (step S6) to become the combined image data corresponding to the original document. Then, the synthesized image data, which is expressed in the form of the CMYK, is output to the printer unit 30 (step S7).

The printer unit 30 receives the image data to perform the printing on the print material, and the copy is completed.

Further, in the above-mentioned embodiment, it is described that the process is performed by directly outputting the image data generated by the image processing unit 20 to the printer unit 30. However, the image data obtained after being synthesized (S6) may be output as a file in a predetermined format.

In addition, in the above-mentioned embodiment, the RGB, Lab, and CMYK are used for the color expression format of the image data, but all of these are only examples, and thus other expression formats may be employed.

As described above, in the copying apparatus 1 according to the embodiment of the invention, when the copying process (the image process) is performed, the individual LUT for the color conversion including the primary coloring upon outputting is dynamically generated so as to be suitable for the image according to the content (characteristics) of the processing target image. In addition, the color conversion process is performed using the individual LUT. Therefore, the portion to be reproduced in the primary color in the image can be reliably realized in the primary color. In addition, the portion not to be reproduced in the primary color can be prevented from being output in the primary color, so that it is possible to output a high quality image. In other words, since the copying apparatus 1 generates the individual LUT for each processing target image, the pixels including the same colorific value in a different image may be converted to be output in the primary color on the one hand, and may be converted to be output in plural colors on the other hand.

In addition, since the FG region and the BG region are used to determine the region of the colorific value to be reproduced in the primary color, the primary coloring is actively performed on the text or the graphic. On the other hand, the primary coloring is prevented from being performed on the portion included in the photograph or the like.

Further, in the embodiment, the processes performed by the image processing unit 20 are executed by the operation of the CPU 21 according to the programs, but these processes may be executed by an ASIC or the like. And the programs may be recording in a computer-readable recording medium.

The scope of the present invention is not limited to the embodiment described above, but the invention described in the claims and the equivalent are included in the scope of the present invention.

The entire disclosure of Japanese Patent Application No. 2008-262722, filed Oct. 9, 2008 is expressly incorporated by reference herein.

What is claimed is:

1. An image processing apparatus for performing a color converting process in which image data of an original document obtained by a reading apparatus is converted into image data expressed in a color space corresponding to a coloring material used in an output apparatus, the image processing apparatus comprising:
a conversion information generating unit which generates data for the color converting process when the color converting process is performed, the data corresponding to one or more images included in the image data of the original document; and
a color converting unit which performs the color converting process using the data for the generated color converting process, the data corresponding to the image data of each image,
wherein the data for the color converting process includes information which is used to convert the image data of the image before conversion such that the image data is expressed in one color of the coloring material used in the output apparatus after conversion.

2. The image processing apparatus according to claim 1,
wherein the data for the color converting process includes information which is used to convert a calorific value of the image before conversion such that the image data is expressed in one color of the coloring material used in the output apparatus after conversion, the image being positioned in a region which is determined on the basis of a range including an edge portion in the image and a portion, which has a color approximating to the color of the edge portion, in the vicinity of the edge portion, and on the basis of a primary color region in the predetermined color space.

3. The image processing apparatus according to claim 1,
wherein the data for the color converting process is generated for each object included in the image data of the original document.

4. The image processing apparatus according to claim 3,
wherein the data for the color converting process is generated on the basis of the kind of the object.

5. A computer-readable recording medium for a recording image processing program causing an image processing apparatus to perform a color converting process in which image data of an original document obtained by a reading apparatus is converted into image data expressed in a color space corresponding to a coloring material used in an output apparatus, the program causing the image processing apparatus to perform:
a conversion information generating step for generating data for the color converting process when the color converting process is performed, the data corresponding to one or more images included in the image data of the original document; and
a color converting step for performing the color converting process using the data for the generated color converting process corresponding to the image data of each image,
wherein the data for the color converting process includes information which is used to convert the image data of the image before conversion such that the image data is expressed in one color of the coloring material used in the output apparatus after conversion.
